(19) United States
(12) Patent Application Publication
(10) Pub. No.: US 2022/0290983 A1
(43) Pub. Date: Sep. 15, 2022

(54) SENSING USING OPTICAL ELEMENTS

(71) Applicant: Tactual Labs Co., New York, NY (US)

(72) Inventor: Braon Moseley, Round Rock, TX (US)

(73) Assignee: Tactual Labs Co., New York, NY (US)

(21) Appl. No.: 17/199,285

(22) Filed: Mar. 11, 2021

(51) Int. Cl. G01B 11/30; G01B 11/26

(52) U.S. Cl. CPC G01B 11/30; G01B 11/26

(57) ABSTRACT

Light emitting elements and light sensing elements are located on the surface of an object. Surface changes of the object are able to be determined by measuring light received at the light sensing elements. Changes with respect to the emission of the light normal to the surface of the object are used to determine changes in the surface.

This application claims the benefit of U.S. Provisional Patent Application Ser. No. 62/987,676 filed Mar. 10, 2020, the contents of which are incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed systems and methods relate in general to the field of sensing, and in particular to sensors implementing light emitting and sensing elements.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is a diagram showing light emitting and sensing elements placed on a substrate.

FIG. 2 is a diagram showing light emitting and sensing elements placed on a substrate showing the vector normal with respect to the substrate and the light emitting and sensing elements.

FIG. 3 is a diagram showing light emitting and sensing elements placed on a substrate showing the normal vector to the light emitting and sensing elements with the sensing element offset from the light emitting element.

FIG. 4 is a diagram showing nodes placed on the surface of the object.

FIG. 5 is a diagram showing interpolated normals from the surface of an object.

FIG. 6 is a diagram showing normals to a surface.

FIG. 7 is a diagram showing a sensor pattern.

FIG. 8 is a diagram of a sensor pattern.

FIG. 9 is a diagram showing a sensor arrangement of the sensor pattern shown in FIG. 8.

FIG. 10 is a diagram of an arrangement of light emitting elements and light sensing elements.

### DETAILED DESCRIPTION

The present application contemplates an improved sensing device implementing fast multi-touch sensing (FMT) chips. FMT chips are suited for use with frequency orthogonal signaling techniques (see, e.g., U.S. Pat. Nos. 9,019,224 and 9,529,476, and 9,811,214, all of which are hereby incorporated herein by reference). The sensor configurations and techniques discussed herein may be used with other signal techniques including scanning or time division techniques, and/or code division techniques. It is also noted that the sensors described and illustrated herein are also suitable for use in connection with signal infusion (also referred to as signal injection) techniques and apparatuses.

The presently disclosed systems and methods involve principles related to and for designing, manufacturing and using optical based sensors, and particularly optical based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. Applicants' capacitive based sensing implements the use of orthogonal signals. As such, and for further reference, this application incorporates by reference Applicants' prior U.S. Pat. No. 9,019,224, entitled “Low-Latency Touch Sensitive Device” and U.S. Pat, No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row conductor is coupled (increased) or decoupled (decreased) to a column conductor and the result received on that column conductor. By sequentially exciting the row conductors and measuring the coupling of the excitation signal at the column conductors, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosures of those patents and applications incorporated therein by reference are incorporated herein by reference. This application also employs principles used in fast multi-touch sensors and other interfaces disclosed in the following: U.S. patent application Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristics. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency orthogonal to each other, in which case, they could not be the same frequency.

Certain principles of a fast multi-touch (FMT) sensor have been disclosed in the patent applications discussed above. Orthogonal signals are transmitted into a plurality of transmitting conductors (or antennas) and the information received by receivers attached to a plurality of receiving conductors (or antennas), the signal is then analyzed by a signal processor to capacitively identify touch events. The transmitting conductors and receiving conductors may be organized in a variety of configurations, including, e.g., a matrix where the crossing points form nodes, and interactions are detected at those nodes by processing of the received signals. In an embodiment where the orthogonal signals are frequency orthogonal, spacing between the orthogonal frequencies, Δf, is at least the reciprocal of the measurement period τ, the measurement period τ being equal to the period during which the columns are sampled. Thus, in an embodiment, a column conductor or antenna may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to a row. In an embodiment, the signal processor of the mixed signal integrated circuit (or a downstream component or software) performs a Fourier transform to received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., windows) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

For example, to achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at 4 MHz would yield an integration period slightly longer than a millisecond, and not achieve 1 kHz sampling, and a minimum frequency spacing of 976.5625 Hz.) In an embodiment, the frequency spacing is equal to the reciprocal of the integration period. In such an embodiment, the maximum frequency of a frequency orthogonal signal range should be less than 2 MHz. In such an embodiment, the practical maximum frequency of a frequency orthogonal signal range is preferably less than about 40% of the sampling rate, or about 1.6 MHz. In an embodiment, a DFT (which could be an FFT) is used to transform the digitized received signals into bins of information, each reflecting the frequency of a frequency orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency orthogonal signal that is transmitted. In an embodiment, each DFT (which can be an FFT) bin comprises an in-phase (I) and quadrature (Q) component. In an embodiment, the sum of the squares of the I and Q components is used as a measure corresponding to signal strength for that bin. In an embodiment, the square root of the sum of the squares of the I and Q components is used as measure corresponding to signal strength for that bin. It will be apparent to a person of skill in the art in view of this disclosure that a measure corresponding to the signal strength for a bin could be used as a measure related to activity, touch events, etc. In other words, the measure corresponding to signal strength in a given bin would change as a result of some activity proximate to the sensors, such as a touch event.

The sensing apparatuses discussed herein use light emitting and sensing elements. However, it should be understood that whether the light emitting and sensing elements are functioning as a transmitter of light signals, a receiver of light signals, or both depends on context and the embodiment. In an embodiment, the light emitting and sensing elements for all or any combination of patterns are operatively connected to a single integrated circuit capable of transmitting and receiving the required signals. In an embodiment, the transmitters and receivers are each operatively connected to a different integrated circuit capable of transmitting and receiving the required signals, respectively. In an embodiment, the light emitting and sensing elements for all or any combination of the patterns may be operatively connected to a group of integrated circuits, each capable of transmitting and receiving the required signals, and together sharing information necessary to such multiple IC configuration. In an embodiment, where the capacity of the integrated circuit (i.e., the number of transmit and receive channels) and the requirements of the patterns (i.e., the number of transmit and receive channels) permit, all of the light emitting and sensing elements for all of the multiple patterns used by a controller are operated by a common integrated circuit, or by a group of integrated circuits that have communications therebetween. In an embodiment, where the number of channels requires the use of multiple integrated circuits, the information from each circuit is combined in a separate system.

In an embodiment, the mixed signal integrated circuit is adapted to generate one or more signals and transmit the signals to the light emitting elements. In an embodiment, the mixed signal integrated circuit is adapted to generate a plurality of frequency orthogonal signals and send the plurality of frequency orthogonal signals to the light emitting elements. In an embodiment, the mixed signal integrated circuit is adapted to generate a plurality of frequency orthogonal signals and one or more of the plurality of frequency orthogonal signals to each of a plurality of light emitting elements. The frequency spacing between the frequency orthogonal signals should be greater than or equal to the reciprocal of the integration period (i.e., the sampling period).

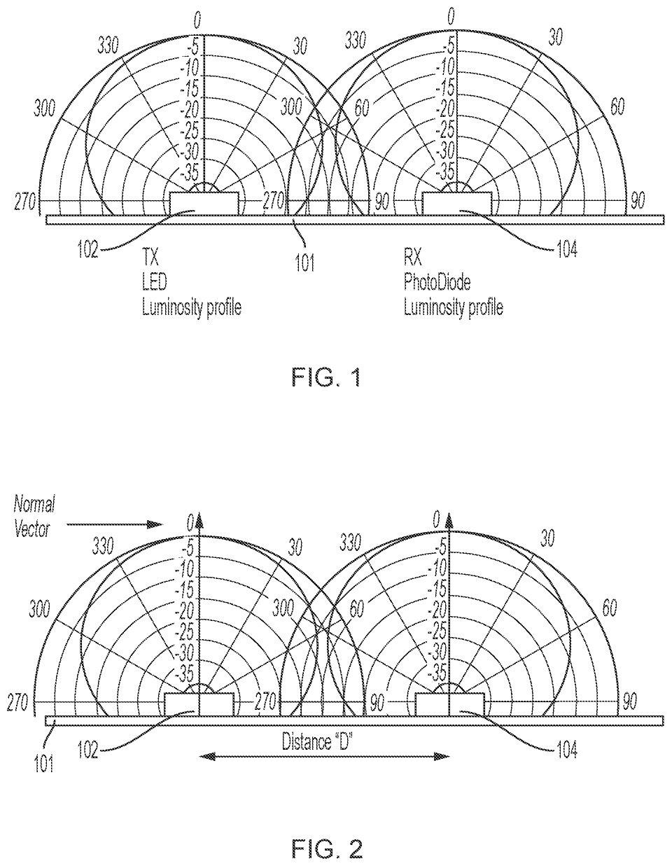

FIG. 1 is a diagram showing a light emitting element 102 and a sensing element 104 located on a substrate 101. FIG. 1 shows the luminosity profile of the light emitting element 102 and the irradiance profile of the light sensing element 104. Using information regarding the capabilities of the light emitting elements 102 and the light sensing elements 104 the respective elements can be placed on objects. The placement of the light emitting elements 102 and the light sensing elements 104 can be used to determine information regarding the topography of the objects.

In an embodiment, the light emitting elements 102 and the light sensing elements 104 can be placed in such a manner that measurements of received signals from adjacent light emitting elements 102 and light emitting elements 102 further away can be used in order to determine the shape of the surface upon which the light emitting element 102 and the light sensing elements 104 are placed. The normal vector to the surface of the substrate 101 has three degrees of freedom and can be calculated directly. Understanding the relative vectors from multiple points throughout the area of a three dimensional surface allows an approximation of the curvature of the surface. This information can be used to dynamically determine changes in the topography of any object upon which the light emitting elements 102 and the light sensing elements 104 are located.

FIG. 2 is a diagram showing light emitting element 102 and light sensing element 104 placed on a substrate 101 showing the normal vector to the light emitting element 102 and light sensing element 104. The distance between the light sensing element 104 and the light emitting element 102 can be known via the design process, i.e. predetermining via the manufacturing process or the assembly process where each element is to be located. The distance between the light sensing element 104 and the light emitting element 102 can be known through establishing their location, i.e. by taking an initial set of conditions, transmitting and receiving a plurality of signals and taking measurements of the received signals to establish location of light emitting elements 102 and light sensing elements 104 with respect to each other. The normal from a light emitting element 102 and the normal from a light sensing element 104 can have their baseline established so that the normals are parallel with respect to each other. Any change in the normal vector of the light emitting element 102 and the sensing element 104 can be determined by establishing the change in angle with respect to the established parallel normals.

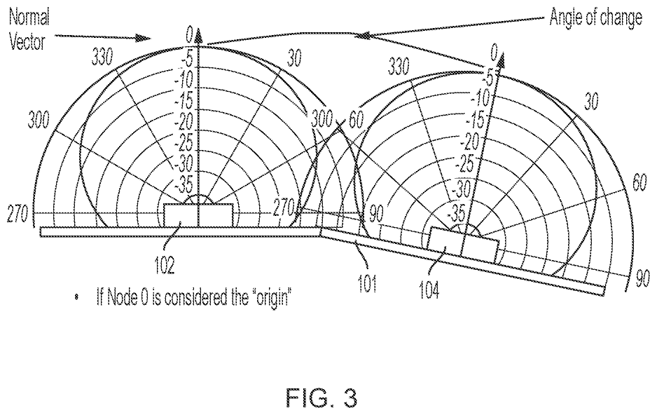

FIG. 3 shows the angle of change between the normals of the light emitting element 102 and the light sensing element 104. The angle offset can be calculated because the coupling between the light emitting element 102 and the light sensing element 104 will change. The profiles of the respective light emitting element 102 and light sensing element 104 are established and known. By establishing the distance between the light emitting element 102 and the light sensing element 104 changes in the luminosity profile can be established.

The angular offset of the light emitting element 102 with respect to the light sensing element 104 can be determined based on changes of the measured light and using the predetermined distance between the light emitting element 102 and the light sensing element 104. The measurement between each pair of light emitting elements 102 and light sensing elements 104 will change based on their changing physical locations. Light emitted from adjacent and non-adjacent light emitting elements 102 can be measured. Distinguishing between the light emitting elements 102 can be accomplished by distinguishing the frequency of the received light.

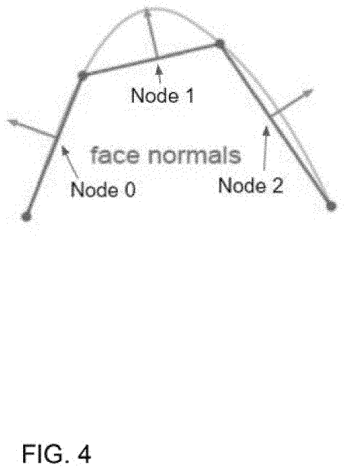

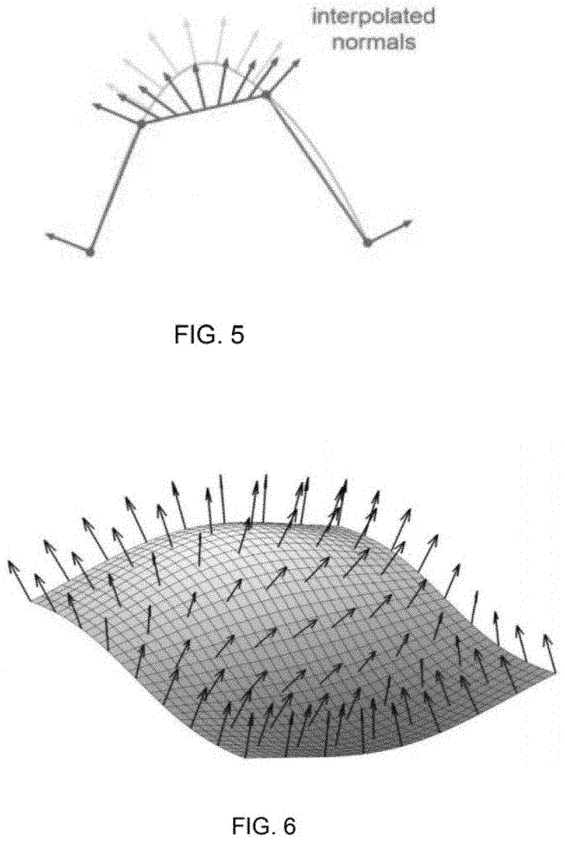

FIG. 4 is a diagram showing elements placed on the surface of an object forming nodes on the surface from which signals can be measured. FIG. 5 is a diagram showing the interpolated normals from the surface of an object. FIG. 6 is a diagram of a surface showing normals to the surface.

By having a plurality of light emitting elements and light sensing elements the changing shape of an object can be determined. The substrate upon which the elements are placed may be deformable and capable of conforming to various objects. In an embodiment, each light emitting element emits light at a different frequency from each other light emitting element. Each sensing element can use received light in order to determine where the light was emitted.

In an embodiment, the topography of a fabric is determined using the elements. In an embodiment, the topography of a seat is determined. In an embodiment, the topography of an inflatable item is determined. In an embodiment, the topography of furniture is determined. In an embodiment, the topography of a room is determined. In an embodiment, the changing shape of a surface is determined. In an embodiment, the changing shape of clothing is determined. In an embodiment, the contours of vehicles are determined. In an embodiment, the contours of textiles are determined.

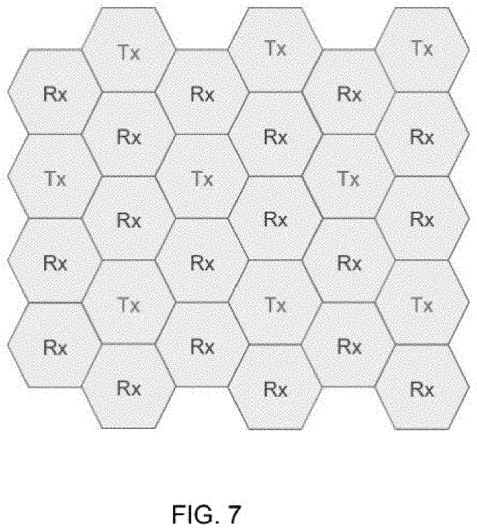

FIG. 7 is a diagram showing a sensor pattern formed by having a transmitting antenna surrounded by a plurality of receiving antennas. In an embodiment, the transmitting antennas are light emitting elements and the receiving antennas are light sensing elements. Having a hexagonal array of antennas can help to eliminate dead spots that may be produced when square lattices of antennas are used. This handles crosstalk across diagonal nearest neighbors. With optical sensing, emitted rays will likely have isotropic scattering with objects. Having a hexagonal pattern can improve signal detection by the light sensing elements.

When implementing fewer transmitting antennas or light emitters there will be less overlap in the viewing angle for each unique frequency signature, possibly creating greater resolution at a given height above the sensor array.

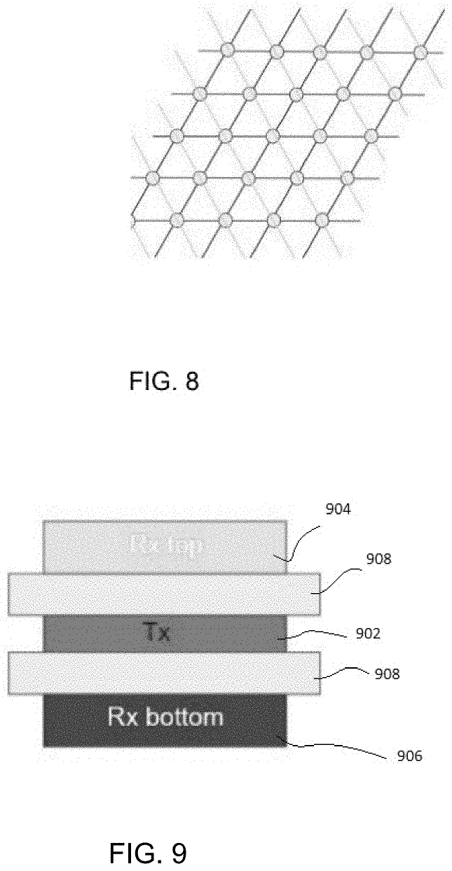

FIGS. 8 and 9 show another diagram of a sensor pattern. As discussed above, a hexagonal array can help to eliminate dead spots from square lattices for crosstalk across the diagonal nearest neighbors. A similar design can be implemented with transmitting antennas and receiving antennas. This can be implemented by having a layer of transmitting antennas 902, a first layer having receiving antennas 904 and a second layer of receiving antennas 906 located below the layer of transmitting antennas (shown in FIG. 9). Between the layers there can be spacing layers 908. Compared to a square lattice, this arrangement provides 6 nearest neighbors (compared to 4), and 12 next nearest neighbors (compared to 8).

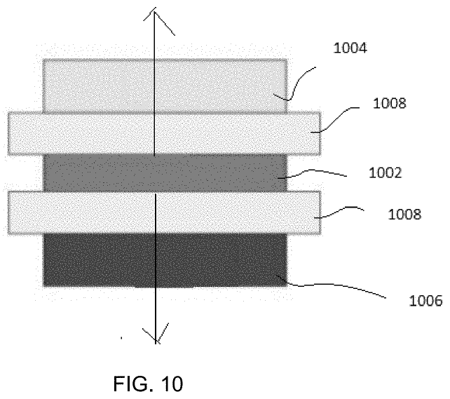

Referring now to FIG. 10, the arrangement discussed above with respect to FIGS. 8 and 9 can be used to create a layer of light emitting elements 1002 located on a middle layer. Light sensing elements 1004 are then located on a first layer and light sensing elements 1006 are located on a second layer. In an embodiment, there are spacing layers 1008 that in an embodiment are adapted to have light transmitted therethrough.

In an embodiment, the light sensing elements are placed in a manner so that they extend in a different lengthwise direction than the placement of the light sensing elements on the different layer. In an embodiment, the light sensing elements are placed in a manner so that they extend in a lengthwise direction in an alternating spacing pattern than the light sensing elements on the second layer.

In an embodiment, the light emitting elements can transmit light in two directions normal to the light emitting layer (shown by the arrows). That is to say In an embodiment, surface changes of the first and second layers can be detected directly via the light sensing elements. In an embodiment only one layer of light sensing elements is implemented and movement of either the first layer or the second layer is inferred from the movement of the other layer. In an embodiment, there are more than first and second layers. In an embodiment, there are more than one layer of light emitting elements.

An aspect of the disclosure is a sensing system. The sensing system comprising: at least one light emitting element adapted to be placed on an object, wherein the light emitting element is adapted to emit light normal to the at least one light emitting element; at least one light sensing element adapted to be placed on the surface of the object at a location a first distance from the at least one light emitting element; and a processor adapted to process measurements of light received at the at least one light sensing element and determine an angular change of the light emitting element with respect to the light sensing element by using measurements of the light received at the light sensing element, wherein the processed measurements are used to determine changes with respect to topography of the surface of the object.

Another aspect of the disclosure is a sensing system. The sensing system comprising: a plurality of light emitting elements each of the plurality of light emitting elements adapted to be placed on a surface, wherein the light emitting element is adapted to emit light normal to the at least one light emitting element; at least one light sensing element adapted to be placed on the surface at a location a distance from each of the plurality of light emitting elements; and a processor adapted to process measurements of light received at the at least one light sensing element and determine an angular change of at least one of the plurality of light emitting elements with respect to the light sensing element by using measurements of the light received at the light sensing element, wherein the processed measurements are used to determine changes with respect to topography of the surface.

Still yet another aspect of the disclosure is a sensing system. The sensing system comprising: at least one light emitting element adapted to be placed on a surface, wherein the light emitting element is adapted to emit light normal to the at least one light emitting element; a plurality of light sensing elements adapted to be placed on the surface ata locations distant from the at least one light emitting element; and a processor adapted to process measurements of light received at at least one of the plurality of light sensing elements and determine an angular change of the at least one light emitting element with respect to the light sensing element by using measurements of the light received at the at least one of the plurality of light sensing elements, wherein the processed measurements are used to determine changes with respect to topography of the surface.

While the invention has been particularly shown and described with reference to a preferred embodiment thereof, it will be understood by those skilled in the art that various changes in form and details may be made therein without departing from the spirit and scope of the invention.

1. A sensing system, comprising:
at least one light emitting element adapted to be placed on an object, wherein the at least one light emitting element is adapted to emit light normal to the at least one light emitting element;
at least one light sensing element adapted to be placed on the surface of the object at a location a first distance from the at least one light emitting element; and
a processor adapted to process measurements of light received at the at least one light sensing element and determine an angular change of the at least one light emitting element with respect to the at least one light sensing element by using measurements of the light received at the at least one light sensing element, wherein the processed measurements are used to determine changes with respect to topography of the surface of the object; and
at least one other light sensing element, wherein the at least one other light sensing element is located on another surface opposite the surface.

2. The sensing system of claim 1, wherein the at least one light element is one of a plurality of light emitting elements.

3. The sensing system of claim 2, wherein each of the plurality of light emitting elements emits light at a frequency different from each other of the plurality of light emitting elements.

4. The sensing system of claim 1, wherein the at least one light sensing element is one of a plurality of light sensing elements.

5. The sensing system of claim 4, wherein at least one other of the plurality of light sensing elements is located on an interior surface of the object.

6. The sensing system of claim 1, wherein the at least one light emitting element is adapted to transmit light in at least two different directions normal to the at least one light emitting element.

7. The sensing system of claim 6, wherein at least one of the at least two directions is towards an interior of the object.

8. The sensing system of claim 7, wherein the at least one of the at least two directions is towards an exterior of the object.

9. The sensing system of claim 1, wherein the object is a seat.

10. The sensing system of claim 1, wherein the at least one light emitting element and the at least one light sensing element are part of a pattern that is hexagonally shaped.

11. A sensing system, comprising:
a plurality of light emitting elements, each of the plurality of light emitting elements adapted to be placed on a surface, wherein at least one of the plurality of light emitting elements is adapted to emit light normal to the at least one of the plurality of light emitting elements;
at least one light sensing element adapted to be placed on the surface at a location a distance from each of the plurality of light emitting elements; and
a processor adapted to process measurements of light received at the at least one light sensing element and determine an angular change of at least one of the plurality of light emitting elements with respect to the light sensing element by using measurements of the light received at the at least one light sensing element, wherein the processed measurements are used to determine changes with respect to topography of the surface: and
at least one other light sensing element, wherein the at least one other light sensing element is located on another surface opposite the surface.

12. The sensing system of claim 11, wherein each of the plurality of light emitting elements emits light at a frequency different from each other of the plurality of light emitting elements.

13. The sensing system of claim 11, wherein the location of the at least one light sensing element with respect to each of the plurality of light emitting elements is predetermined.

14. (canceled)

15. The sensing system of claim 11, wherein at least one of the plurality of light emitting elements is adapted to transmit light in at least two different directions normal to the at least one of the plurality of light emitting elements.

16. The sensing system of claim 15, wherein at least one of the at least two directions is towards an interior direction from the surface.

17. The sensing system of claim 15, wherein the at least one of the at least two directions is away from the surface.

18. The sensing system of claim 11, wherein the surface is part of a seat.

19. The sensing system of claim 11, wherein the plurality of light emitting elements and the at least one light sensing element are part of a pattern that is hexagonally shaped.

20. A sensing system, comprising:
at least one light emitting element adapted to be placed on a surface, wherein the at least one light emitting element is adapted to emit light normal to the at least one light emitting element;
a plurality of light sensing elements adapted to be placed on the surface at a locations distant from the at least one light emitting element; and
a processor adapted to process measurements of light received at at least one of the plurality of light sensing elements and determine an angular change of the at least one light emitting element with respect to at least one of the plurality of light sensing elements by using measurements of the light received at the at least one of the plurality of light sensing elements, wherein the processed measurements are used to determine changes with respect to topography of the surface: and
at least one other light sensing element, wherein the at least one other light sensing element is located on another surface opposite the surface.
